(19) United States
(12) Patent Application Publication
(10) Pub. No.: US 2014/0362214 A1
(43) Pub. Date: Dec. 11, 2014

(54) APPARATUS AND METHOD FOR PROCESSING IMAGE SIGNAL

(71) Applicant: Hyundai Motor Company, Seoul (KR)

(72) Inventor: Ui Dong Lee, Suwon (KR)

(73) Assignee: Hyundai Motor Company, Seoul (KR)

(21) Appl. No.: 14/049,531

(22) Filed: Oct. 9, 2013

(30) Foreign Application Priority Data
Jun. 5, 2013 (KR) 10-2013-0064852

(51) Int. Cl. H04N 5/268

(52) U.S. Cl. CPC H04N 5/268
USPC 348/143

(57) ABSTRACT

An apparatus and a method are arranged to process an image signal including: a Central Processing Unit (CPU) which outputs a digital image corresponding to an input image from an image collection apparatus to an image display apparatus; a controller, or micom, which monitors an operation state of the CPU, and outputs a control signal depending on occurrence of an error in the CPU; and an image switch which switches an image output mode to one of a digital image mode and an analog image mode according to the control signal which is output through the micom in an input terminal of the CPU.

### CROSS-REFERENCE TO RELATED APPLICATION

This application is based on and claims under 35 U.S.C. §119(a) priority from Korean Patent Application No. 10-2013-0064852, filed on Jun. 5, 2013 in the Korean Intellectual Property Office, the disclosure of which is incorporated herein in its entirety by reference.

### BACKGROUND

(a) Field of the Invention

The present invention relates to an apparatus and a method for processing an image signal, and more particularly, to an arrangement for controlling an image switch according to a state of a Central Processing Unit (CPU) processing a digital image.

(b) Description of the Related Art

Currently, certain vehicles are equipped with a separate image collection apparatus for capturing images around a vehicle in order to secure a viewing angle of a driver during parking and driving, which enables the driver to use image information around the vehicle through a multimedia apparatus inside of the vehicle.

In particular, a CPU of the multimedia apparatus may control to receive image information of the image collection apparatus and display the information after adding a vehicle or driving information.

However, when a breakdown occurs in the CPU, the multimedia apparatus is not able to support a camera image mode such that a mode of using the camera image is not available, for example, a user cannot verify a camera image when operating a parking supporting mode. Accordingly, ease and safety desired by user may be reduced.

### SUMMARY

The present invention provides an apparatus and a method for processing an image signal that continuously outputs an image even if an error has occurred in a Central Processing Unit (CPU) that processes a digital image in a vehicle multimedia apparatus.

In particular, the present invention further provides an apparatus and a method for processing an image signal that outputs an analog image by controlling an image switch and an output switch when an error occurs in the CPU that processes a digital image.

In accordance with an aspect of the present invention, an image signal processing apparatus includes: a Central Processing Unit (CPU) which outputs a digital image corresponding to an input image from an image collection apparatus to an image display apparatus; a micom which monitors an operation state of the CPU, and outputs a control signal depending on occurrence of an error in the CPU; and an image switch which switches an image output mode to one of a digital image mode and an analog image mode according to the control signal which is output through the micom in an input terminal of the CPU. The micom outputs a second control signal which switches to the analog image mode when an error occurs in the CPU. The micom outputs a first control signal which switches to the digital image mode when the error occurred in the CPU is restored. The micom outputs the control signal to the image switch and an output switch of the image display apparatus. The output switch switches to one of a digital image input terminal and an analog image input terminal of the image display apparatus according to the control signal which is output from the micom.

In accordance with an aspect of the present invention, an image signal processing apparatus further includes: an image decoder which outputs the input image to the CPU by converting into a digital signal, when the image output mode is switched to a digital image mode. The image switch drives a switch to output the input image to the image decoder at the time of digital image mode, and drives a switch to output the input image to an analog image input terminal of the image display apparatus at the time of the analog image mode. An output terminal of the CPU is connected to a digital image input terminal of the image display apparatus. The CPU receives driving information of a vehicle, and outputs to the output display apparatus after combining the driving information to the digital image.

In accordance with another aspect of the present invention, a method of processing an image signal includes: converting an input image from an image collection apparatus into a digital image by an image decoder when in a digital image mode; outputting the digital image to a digital image input terminal of an image display apparatus, by a CPU; monitoring a state of the CPU, and outputting a control signal to switch an image output mode to an analog image mode when an error occurs in the CPU, by a micom; and switching the image output mode to an analog image mode so that the input image is output to an analog image input terminal of the image display apparatus according to the control signal, by the image switch.

In accordance with another aspect of the present invention, a method of processing an image signal further includes: switching an output switch of the image display apparatus to one of the digital image input terminal and the analog image input terminal according to the control signal.

In accordance with another aspect of the present invention, a method of processing an image signal further includes, after the input image is output to an analog image input terminal of the image display apparatus, outputting a control signal by the micom at the time of restoring an error occurred in the CPU so that the image output mode is switched to a digital image mode.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a system configuration to which an image signal processing apparatus is applied according to the present invention;

FIG. 2 is a block diagram illustrating a configuration of an image signal processing apparatus applied to the system configuration of FIG. 1 according to the present invention;

FIG. 3 is an exemplary diagram explaining an operation of the image signal processing apparatus of FIG. 2 according to a first exemplary embodiment of the present invention;

FIG. 4 is an exemplary diagram explaining an operation of the image signal processing apparatus of FIG. 2 according to a second exemplary embodiment of the present invention; and

FIG. 5 is a flow chart illustrating an operation flow corresponding to an image signal processing method according to the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that the below methods are executed by at least one controller. The term “controller” refers to a hardware device that includes a memory and a processor. The memory is configured to store modules, and the processor is specifically configured to execute the modules to perform one or more processes which are described further below.

Further, the control logic of the present invention may be embodied in a non-transitory computer readable medium containing executable program instructions executed by a processor, controller, or the like. Examples of computer readable media include, but are not limited to, ROM, RAM, compact disc (CD)-ROMs, magnetic tapes, floppy disks, smart cards, and optical data storage devices. The computer readable recording medium can also be distributed in network coupled computer systems so that the computer readable medium is stored and executed in a distributed fashion, e.g., by a telematics server or a Controller Area Network (CAN).

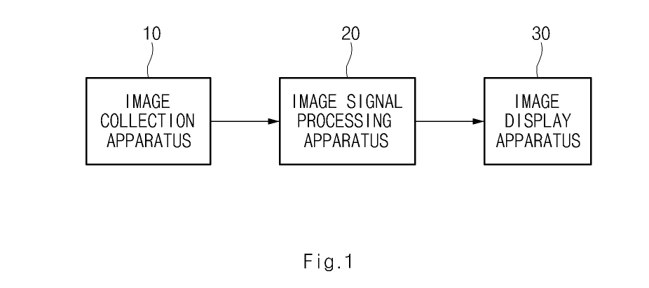

FIG. 1 is a diagram illustrating a system configuration to which an image signal processing apparatus is applied according to the present invention. A system to which the image signal processing apparatus 20 is applied according to the present invention includes an image collection apparatus 10 and an image display apparatus 30.

The image collection apparatus 10 preferably produces an image (i.e., one or more still, moving, and/or panoramic images) around a vehicle and provides the image to the image signal processing apparatus, and may constitute a camera which is placed in at least one of a direction of a front, rear, left, and right of a vehicle. In particular, the image collection apparatus 10 provides the image obtained from the surrounding of the vehicle at the time of operating a camera image mode by the multimedia apparatus inside of the vehicle to the image signal processing apparatus 20.

As an example, the image collection apparatus 100 may be driven by a parking supporting system of a vehicle, and an Around View Monitoring (AVM).

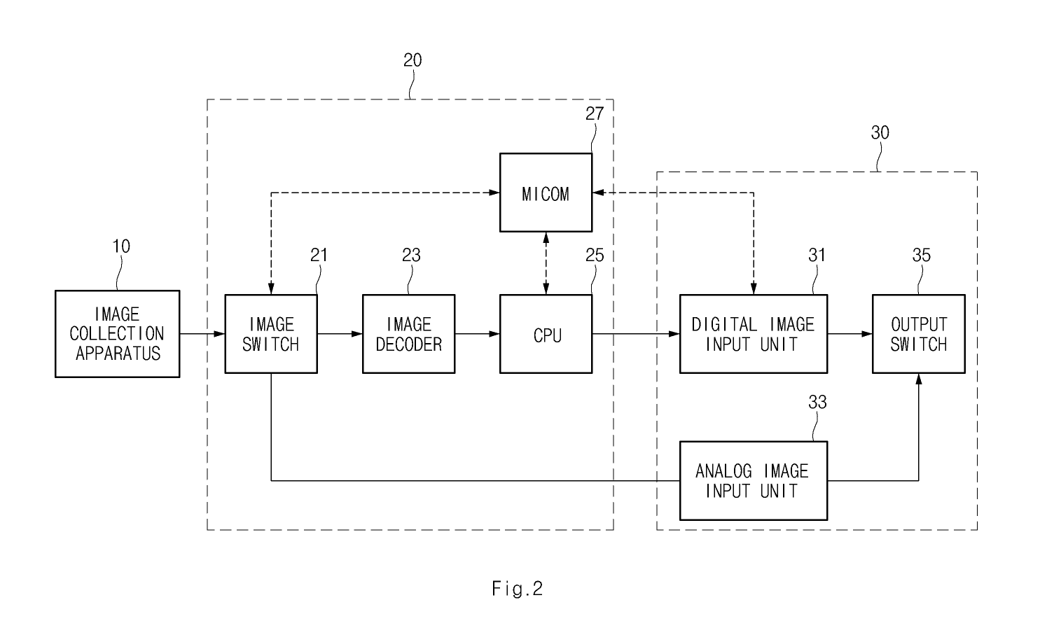

The image signal processing apparatus processes an input image from the image collection apparatus 10 according to an output mode and provides it to the image display apparatus 30. Here, the input image is an analog image photographed by a camera. At this time, the image signal processing apparatus 20 operates as the digital image mode, or as an analog image mode according to a state of the Central Processing Unit (CPU). Accordingly, a configuration corresponding to the image signal processing apparatus 20 is described in more detail with reference to FIG. 2.

The image display apparatus 30 may include a monitor and a navigation screen which are equipped in the vehicle. The image display apparatus 30 outputs an image which is providing from the image signal processing apparatus 20 at the time of a camera image mode. Here, the image display apparatus 30 may output a digital image along with the driving information of the vehicle in the digital image mode. On the other hand, the image display apparatus 30 may output only an analog image in an analog image mode.

FIG. 2 is a block diagram illustrating a configuration of an image signal processing apparatus according to the present invention. Referring to FIG. 2, the image signal processing apparatus 20 may include an image switch 21, an image decoder 23, a CPU 25, and a micom 27.

The image switch 21 switches the image output mode according to a state of a control signal which is output from the micom 27. In particular, the image switch 21 switches the image output mode to any one of the digital image mode and the analog image mode according to the control signal of the micom 27, and determines a delivery pathway of an input image which is input from the image collection apparatus 10 according to the switched image output mode.

In particular, the image switch 21 drives the switch so that the input image may be output to the image decoder 23 in the digital image mode, and drives the switch so that the input image may be output to the analog image input unit 33 of the image display apparatus 30 in the analog image mode.

In the image decoder 23, an input terminal is connected to the image switch 21, and an output terminal is connected to the CPU 25. Therefore, the image decoder 23 converts the input image which is delivered through the image switch 21 into the digital signal and outputs to the CPU 25 when the image output mode is switched to the digital image mode.

In the CPU 25, an input terminal is connected to the image decoder 23, and an output terminal is connected to the digital image input unit 31 of the image display apparatus 30. Accordingly, the CPU 25 outputs the digital image input from the image decoder 23 to the digital image input unit 31 of the image display apparatus 30. On the other hand, the CPU 25 may receive the driving information which is collected through a sensor equipped in the vehicle. In this case, the CPU combines the driving information to the digital image input from the image decoder 23 and outputs to the image display apparatus 30.

The micom 27 monitors an operation state of the CPU 25 while the input image is outputting. In particular, the micom 27 outputs a corresponding control signal depending on the error of the CPU 25. The micom 27 as described herein functions as a controller, and thus monitors the CPU 25, and is configured to output one or more control signals.

As an example, the micom 27 outputs a first control signal which enables to switch to the digital image mode at the time of a normal operation to the image switch 21. Meanwhile, the micom 27 outputs a second control signal which enables to switch to the analog image mode at the time of the error occurrence in the CPU 25 to the image switch 21. Therefore, as the image switch 21 switches the image output mode to the analog image mode by the second control signal, the input image is output directly to the analog image input unit 33 of the image display apparatus 30 without passing through the CPU 25. In this case, when restoring the error occurred in the CPU 25, the micom 27 outputs the first control signal which enables to switch into the digital image mode to the image switch 21.

In particular, the CPU 25 and the micom 27 may be disposed on different substrate respectively, however, may be disposed on one substrate according to an implement type.

In the meantime, the image display apparatus 30 may include an output switch 35. In particular, the output switch 35 switches to one of the digital image input unit 31 and the analog image input unit 33 according to the state of the control signal which is output from the micom 27. As an example, the output switch 35 drives the switch to be connected to the digital image input unit 31 at the time of the digital image mode, and drives the switch to be connected to the analog image input unit 33 at the time of the analog image mode.

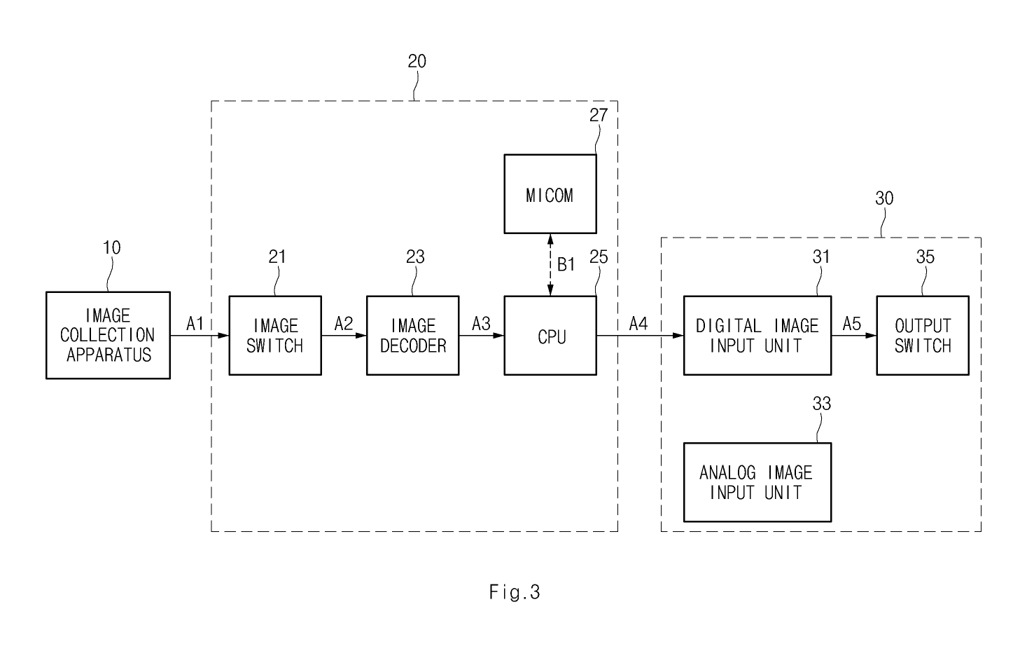

FIG. 3 is an exemplary diagram explaining an operation of an image signal processing apparatus according to a first exemplary embodiment of the present invention. FIG. 3 shows an exemplary embodiment when the CPU 25 of the image signal processing unit 20 operates normally.

FIG. 3 is described on the assumption that an image switch 21 and an output switch 35 are switched to a digital image mode as the CPU 25 operates normally. As illustrated in FIG. 3, when the input image is received from the image collection apparatus 10 through a pathway ‘A1’, the image switch 21 makes the input image to be output to the image decoder 23 through a pathway ‘A2’. Therefore, the image decoder 23 converts the input image into the digital image, and outputs to the CPU 25 through a pathway ‘A3’.

The CPU 25 may output the digital image received from the image decoder 23 directly to the digital image input unit 31 in the image display apparatus 30 through a pathway ‘A4’. However, the CPU may also output to the digital image input unit 31 after combining the driving information with the digital image when the driving information of the vehicle is received. In this case, the driving information may be combined as OSD information of the digital image.

Therefore, the digital image input unit 31 of the image display apparatus 30 outputs the digital image through the pathway ‘A4’ to the output switch 35 through a pathway ‘A5’.
In particular, the micom 27 transmits and receives a signal with the CPU continuously through a pathway ‘B1’ to monitor the state of the CPU 25. While the CPU 25 operates normally, the micom 27 only monitors the state of the CPU 25 continuously.

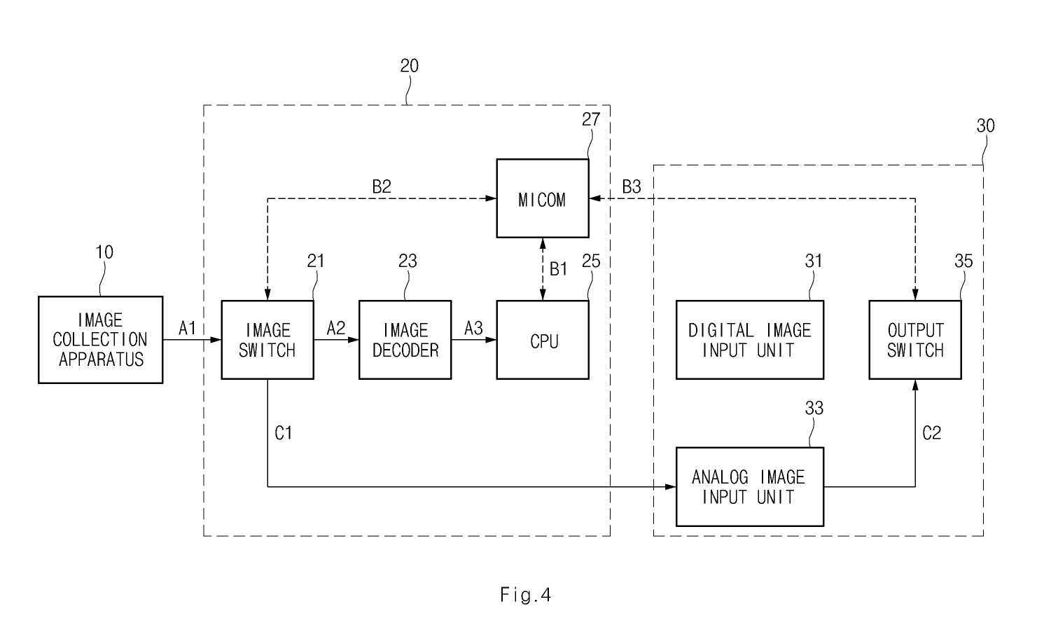

Meanwhile, FIG. 4 is an exemplary diagram explaining an operation of an image signal processing apparatus according to a second exemplary embodiment of the present invention, and shows an exemplary embodiment when an error occurs in the CPU 25 of the image signal processing apparatus. 20.

Referring to FIG. 4, when the input image is received through a pathway ‘A1’, the image switch 21 enables the input image to be output from the image collection apparatus 10 to the image decoder 23 through a pathway ‘A2’. Therefore, the image decoder 23 converts the input image to the digital image, and outputs to the CPU 25 through a pathway ‘A3’.

When an error occurs in the CPU 25, the micom 27 receives an error signal from the CPU 25 through a pathway ‘B1’, or determines that the error is occurred in the CPU 25 when a normal signal response is not received within a given time period. In particular, the micom 27 outputs a second control signal which enables to switch to the analog image mode through the pathways ‘B2’ and ‘B3’. Therefore, the image switch 21 drives the switch to make the input image to be output to the image input unit 33 according to a second control signal, and drives the switch to be connected to the output switch 35 or the analog image input unit 33.

After that, the image switch 21 makes the input image to be output to the analog image input unit 33 through a pathway ‘C1’, when the input image is received through a pathway ‘A’. Therefore, in the image display apparatus 30, the analog image input unit 33 outputs the input image which is input through a pathway ‘C1’ to the output switch 35 through a pathway ‘C2’.

To be sure, when the error of the CPU 25 is restored, the micom 27 outputs a first control signal which enables to switch to the digital image mode through the pathway ‘B2’ and ‘B3’, such that the input image is able to be output to the image display apparatus 30 through a pathway as FIG. 3.

Hereinafter, the operation flow of a vehicle traffic controlling apparatus in an intersection according to the present invention configured as above is described in more detail.

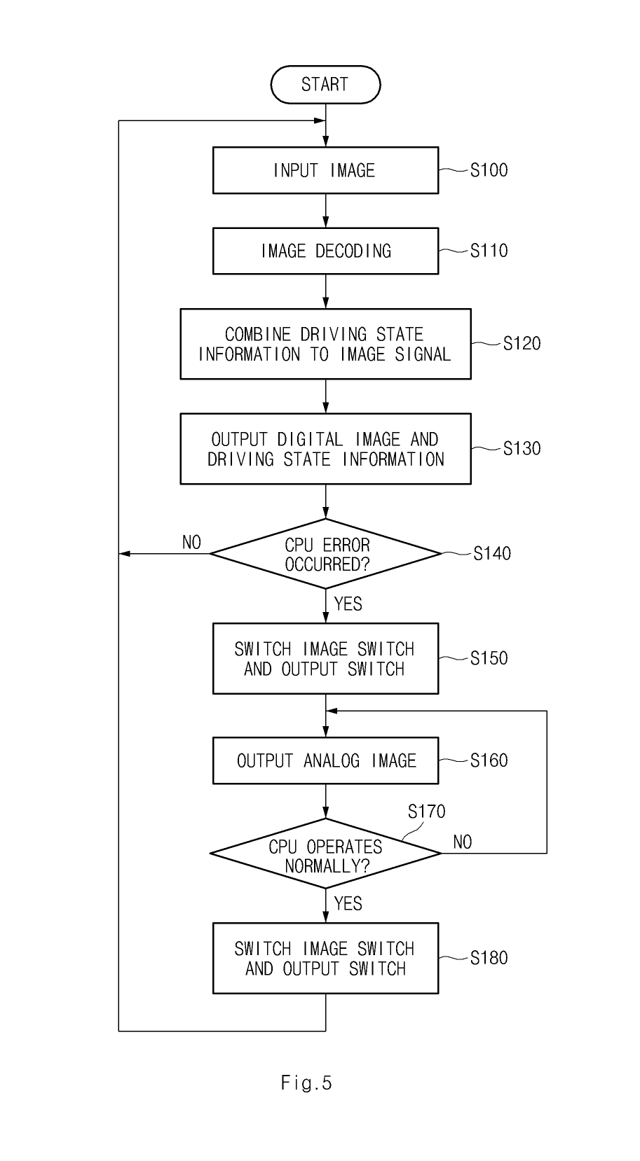

FIG. 5 is a flow chart illustrating an operation flow corresponding to an image signal processing method according to the present invention.

Referring to FIG. 5, in the image signal processing apparatus, when the image is input from the image collection apparatus in the state that the image switch and the output switch are switched into the digital image mode (S100), the input image is output to the image decoder such that the input image is decoded into the digital image (S110). Here, the CPU combines the driving state information of the vehicle to the digital image which is decoded at step 110 (S120), and outputs to the digital image input unit of the image display apparatus such that the digital image and the driving state information is output through the image display apparatus.

On the other hand, when an error occurs in the CPU during the procedures of step 100 to step 130, the micom outputs the control signal which enables the image switch and the output switch to switch to the analog image mode such that the switch is switched (S150).

Therefore, the input image received by the image switch is output by the analog image input unit of the image display apparatus such that the analog image is output through the image display apparatus (S160).

The image signal processing apparatus outputs the analog image through the image display apparatus continuously while the state in which the error occurred in the CPU is maintained, and when the error occurred in the CPU is restored such that the CPU normally operates (S170), the micom outputs the control signal which enables the image switch and the output switch to switch to the digital image mode such that the switch is switched (S180).

Accordingly, the image signal controlling apparatus performs the next procedure of step 100 again.

According to the present invention, it has an advantage of supporting for the camera image mode continuously by controlling an image switch and an output switch to output an analog image even when it is difficult to output the digital image due to the error that occurred in the Central Processing Unit (CPU) processing the digital image in the vehicle multimedia apparatus such as a navigation.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for processing an image signal, the apparatus comprising:
a Central Processing Unit (CPU) which outputs a digital image corresponding to an input image from an image collection apparatus to an image display apparatus;
a micom which monitors an operation state of the CPU, and outputs a control signal depending on occurrence of an error in the CPU; and
an image switch which switches an image output mode to one of a digital image mode and an analog image mode according to the control signal which is output through the micom in an input terminal of the CPU.

2. The apparatus of claim 1, wherein the micom outputs a first control signal which switches to the digital image mode when the CPU operates normally.

3. The apparatus of claim 1, wherein the micom outputs a second control signal which switches to the analog image mode when the error occurs in the CPU.

4. The apparatus of claim 3, wherein the micom outputs a first control signal which switches to the digital image mode when the error that occurred in the CPU is restored.

5. The apparatus of claim 1, wherein the micom outputs the control signal to the image switch and an output switch of the image display apparatus.

6. The apparatus of claim 5, wherein the output switch switches to one of a digital image input terminal and an analog image input terminal of the image display apparatus according to the control signal which is output from the micom.

7. The apparatus of claim 1, further comprising:
an image decoder which outputs the input image to the CPU by converting into a digital signal, when the image output mode is switched to the digital image mode.

8. The apparatus of claim 7, wherein the image switch drives a switch to output the input image to the image decoder when in the digital image mode, and drives a switch to output the input image to an analog image input terminal of the image display apparatus when in the analog image mode.

9. The apparatus of claim 1, wherein an output terminal of the CPU is connected to a digital image input terminal of the image display apparatus.

10. The apparatus of claim 1, wherein the CPU receives driving information of a vehicle, and outputs to the output display apparatus after combining the driving information with the digital image.

11. A method for processing an image signal, the method comprising:
converting an input image from an image collection apparatus into a digital image by an image decoder when in a digital image mode;
outputting the digital image to a digital image input terminal of an image display apparatus, by a CPU;
monitoring a state of the CPU, and outputting a control signal to switch an image output mode to an analog image mode when an error occurs in the CPU, by a micom; and
switching the image output mode to the analog image mode so that the input image is output to an analog image input terminal of the image display apparatus according to the control signal.

12. The method of claim 11, further comprising:
switching an output switch of the image display apparatus to one of the digital image input terminal and the analog image input terminal according to the control signal.

13. The method of claim 11, further comprising, after the input image is output to the analog image input terminal of the image display apparatus, outputting a further control signal by the micom at the time of restoring an error that has occurred in the CPU so that the image output mode is switched to the digital image mode.

14. A non-transitory computer readable medium containing program instructions executed by a controller (micom), the computer readable medium comprising:
providing an input image from an image collection apparatus which is converted into a digital image by an image decoder when in a digital image mode, the digital image being provided to a digital image input terminal of an image display apparatus;
monitoring a state of the CPU, and outputting a control signal to switch an image output mode to an analog image mode when an error occurs in the CPU; and
switching the image output mode to the analog image mode so that the input image is output to an analog image input terminal of the image display apparatus according to the control signal.

15. The computer readable medium of claim 14, further comprising:
switching an output switch of the image display apparatus to one of the digital image input terminal and the analog image input terminal according to the control signal.

16. The computer readable medium of claim 14, further comprising, after the input image is output to the analog image input terminal of the image display apparatus, outputting a further control signal at the time of restoring an error that has occurred in the CPU so that the image output mode is switched to the digital image mode.
